(19) United States
(12) Patent Application Publication
(10) Pub. No.: US 2010/0225696 A1
(43) Pub. Date: Sep. 9, 2010

(54) DROPLET EJECTING DEVICE

(75) Inventor: Hiroshi Shibata, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/716,281

(22) Filed: Mar. 3, 2010

(30) Foreign Application Priority Data
Mar. 5, 2009 (JP) 2009-052134
Feb. 19, 2010 (JP) 2010-035452

(51) Int. Cl. B41J 29/38

(52) U.S. Cl. 347/17

(57) ABSTRACT

A droplet ejecting device includes a recording head, a temperature detector, and moving section. The recording head is elongated, a liquid is filled therein, and plural nozzles, that eject droplets on the basis of image information, are arrayed along a predetermined direction. The temperature detector detects a temperature of a predetermined range of a nozzle surface at which the plural nozzles of the recording head are arrayed. The moving section moves at least one of the temperature detector and the recording head relatively in the predetermined direction.

### CROSS-REFERENCE TO RELATED APPLICATION

This application claims priority under 35 USC 119 from Japanese Patent Applications Nos. 2009-052134 and 2010-035452, filed on Mar. 5, 2009 and Feb. 19, 2010 respectively, the disclosures of which are incorporated by reference herein.

### BACKGROUND OF THE INVENTION

1. Field of the Invention

The present invention relates to a droplet ejecting device that ejects droplets from nozzles.

2. Description of the Related Art

Droplet ejecting devices, that form dots structuring an image on a recording medium by ejecting a liquid from nozzles, are conventionally popular.

In this type of droplet ejecting device, when air bubbles arise in the liquid that is filled within a recording head, the amount of liquid filled within a pressure chamber becomes insufficient due to the air bubbles. When the liquid is ejected from the nozzle, poor ejection may occur.

In order to overcome this problem, Japanese Patent Application Laid-Open (JP-A) No. 7-1745 discloses an image forming device that forms an image on a recording medium by moving a recording head in the transverse direction of a recording medium. The image forming device has a temperature sensor structured by an aluminum thin film whose resistance value changes in accordance with the temperature of the nozzle surface of the recording head. The temperature measured at the temperature sensor and a threshold temperature, that is indicative of entry of air into the recording head, are compared. If the temperature of the recording head is lower than the threshold temperature, the print operation is continued. If the temperature of the recording head is higher than the threshold temperature, correction with respect to entry of air into the recording head is carried out.

However, in the technique disclosed in JP-A No. 7-1745, because the recording head is equipped with the temperature sensor, space for providing the temperature sensor at the recording head is needed. Further, if the recording head is a recording head whose nozzle surface is elongated, plural temperature sensors are needed in order to carry out highly-accurate temperature measurement, and calibration of each of the temperature sensors also is required. Therefore, there is the drawback that the structure for detecting the temperature of the nozzle surface of the recording head becomes complex.

### SUMMARY OF THE INVENTION

The present invention provides a droplet ejecting device in which a recording head is compact, and that, with a simple structure, can detect the temperature of the nozzle surface of the recording head whose nozzle surface is elongated.

An aspect of the present invention is a droplet ejecting device including: a recording head that is elongated, and in which a liquid is filled, and at which plural nozzles, that eject droplets on the basis of image information, are arrayed along a predetermined direction; a temperature detector that detects a temperature of a predetermined range of a nozzle surface at which the plural nozzles of the recording head are arrayed; and a moving section that moves at least one of the temperature detector and the recording head relatively in the predetermined direction.

### BRIEF DESCRIPTION OF THE DRAWINGS

An exemplary embodiment of the present invention will be described in detail based on the following figures, wherein:

FIG. 1 is a side view showing the structure of an image forming device relating to an exemplary embodiment;

FIG. 2 is a longitudinal sectional view of the vicinity of a pressure chamber that is provided at an inkjet line head relating to the exemplary embodiment;

FIG. 3 is a drawing showing the flow path of liquid ink that is supplied from an ink tank to the inkjet line head relating to the exemplary embodiment;

FIG. 4 is a drawing showing the structure of a maintenance section relating to the exemplary embodiment;

FIG. 5 is a block diagram showing the structure of main portions of the electrical system of the image forming device relating to the exemplary embodiment;

FIG. 6 is a flowchart showing the flow of processings of an air bubble discharging program relating to the exemplary embodiment;

FIG. 7A and FIG. 7B are examples of graphs showing computed reference temperature distributions of a nozzle surface of the inkjet line head relating to the exemplary embodiment;

FIG. 8 is an example of a graph showing a computed threshold temperature distribution of the nozzle surface of the inkjet line head relating to the exemplary embodiment; and

FIG. 9 is an example of a graph showing an actually-measured temperature distribution of the nozzle surface of the inkjet line head relating to the exemplary embodiment.

### DETAILED DESCRIPTION OF THE INVENTION

An exemplary embodiment will be described in detail hereinafter with reference to the drawings. Note that, in the exemplary embodiment, description will be given of a case in which an image forming device is used as a droplet ejecting device.

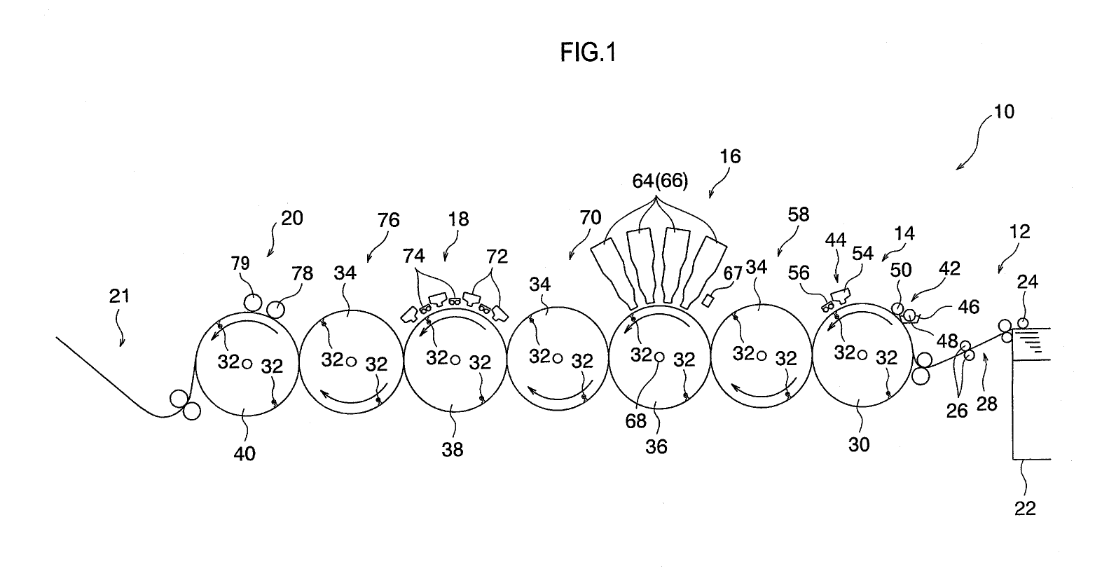

The schematic structure of an image forming device 10 relating to the present exemplary embodiment will be described with reference to FIG. 1.

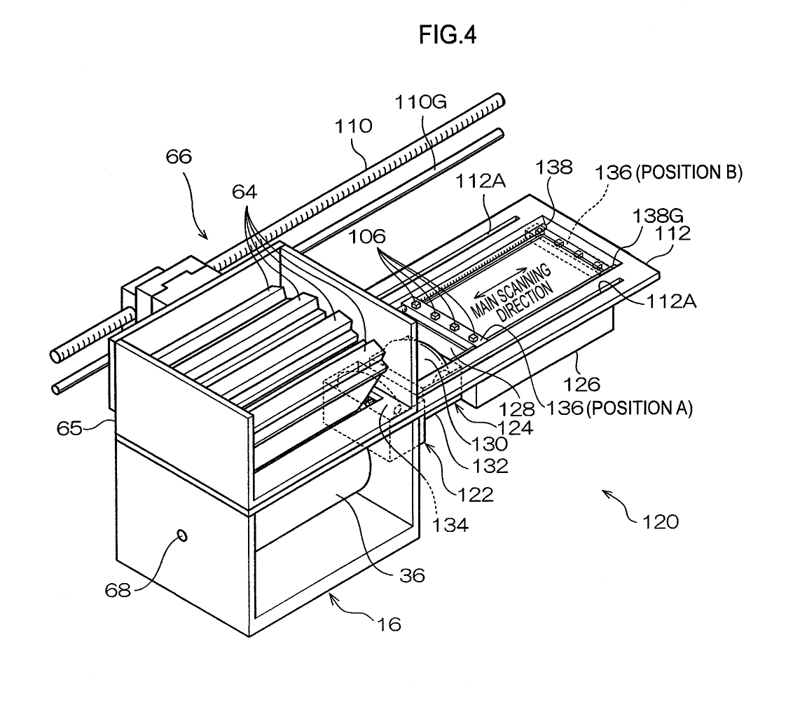

As shown in FIG. 1, a feeding/conveying section 12 that feeds and conveys sheets is provided at the image forming device 10, at the upstream side in the conveying direction of sheets that serve as recording media. Provided along the sheet conveying direction at the downstream side of the feeding/conveying section 12 are: a processing liquid coating section 14 that coats a processing liquid on a recording surface of the sheet, an image forming section 16 that forms an image by liquid ink on the recording surface of the sheet, an ink drying section 18 that dries the image formed on the recording surface, an image fixing section 20 that fixes the dried image to the sheet, and a discharging section 21 that discharges the sheet on which the image is fixed. Further, a maintenance section 120 (see FIG. 4) is provided adjacent to the image forming section 16.

(Feeding/Conveying Section)

A stacking section 22 in which sheets are stacked is provided at the feeding/conveying section 12. A sheet feed portion 24, that feeds one-by-one the sheets that are stacked in the stacking section 22, is provided at the downstream side in the sheet conveying direction of the stacking section 22. (Hereinafter, “upstream” and “downstream” will mean “upstream” and “downstream” in the “sheet conveying direction” unless otherwise specified.) The sheet that is fed by the sheet feed portion 24 is conveyed to the processing liquid coating section 14 via a conveying portion 28 that is structured by plural roller pairs 26.

(Processing Liquid Coating Section)

A processing liquid coating drum 30, that is structured by a cylindrical member and on whose outer peripheral surface a sheet is wound and that conveys that sheet by rotating, is disposed at the processing liquid coating section 14 so as to be rotatable. Holding members 32, that nip the leading end portions of sheets and hold the sheets, are provided at the processing liquid coating drum 30. In the state in which a sheet is held at the surface of the processing liquid coating drum 30 via the holding member 32, the sheet is conveyed downstream by the rotation of the processing liquid coating drum 30.

Intermediate conveying drums 34, an image forming drum 36, an ink drying drum 38 and an image fixing drum 40 that will be described later are structured in the same way as the processing liquid coating drum 30, and further, the holding members 32 are provided thereat. The transfer of a sheet from an upstream drum to a downstream drum is carried out by the holding members 32.

A processing liquid coating device 42 and a processing liquid drying device 44 are disposed along the peripheral direction of the processing liquid coating drum 30 on and above the processing liquid coating drum 30. Processing liquid is coated onto the recording surface of the sheet by the processing liquid coating device 42, and the processing liquid is dried by the processing liquid drying device 44.

The processing liquid reacts with ink, aggregates the color material (pigment), and has the effect of promoting separation of the color material (pigment) and the solvent. A storing portion 46, in which the processing liquid is stored, is provided at the processing liquid coating device 42, and a portion of a gravure roller 48 is soaked in the processing liquid.

A rubber roller 50 is disposed so as to press-contact the gravure roller 48. The rubber roller 50 contacts the recording surface (obverse) of the sheet such that the processing liquid is coated thereon. Further, a squeegee (not shown) contacts the gravure roller 48 and controls the processing liquid coating amount that is coated on the recording surface of the sheet.

It is ideal that the film thickness of the processing liquid is sufficiently smaller than the droplet (the ink drop) ejected by the head. For example, if the droplet amount is 2 pl, the average diameter of the droplet ejected by the head is 15.6 μm. If the film thickness of the processing liquid is thick, the ink dot floats within the processing liquid without contacting the recording surface of the sheet. It is preferable to make the film thickness of the processing liquid be less than or equal to 3 μm in order to obtain a landed dot diameter of greater than or equal to 30 μm at a droplet amount of 2 pl.

On the other hand, at the processing liquid drying device 44, a hot air nozzle 54 and an infrared heater 56 (hereinafter called “IR heater 56”) are disposed near to the surface of the processing liquid coating drum 30. The solvent such as water or the like within the processing liquid is vaporized by the hot air nozzle 54 and the IR heater 56, and a solid or thin-film processing liquid layer is formed on the recording surface of the sheet. By making the processing liquid be a thin layer in the processing liquid drying process, the ink drops that are ejected at the image forming section 16 contact the sheet surface such that the necessary dot diameter is obtained, and the actions of reacting with the processing liquid that has been made into a thin layer, aggregating the color material, and fixing to the sheet surface are easily obtained.

The sheet, on whose recording surface the processing liquid has been coated and dried at the processing liquid coating section 14 in this way, is conveyed to an intermediate conveying section 58 that is provided between the processing liquid coating section 14 and the image forming section 16.

(Intermediate Conveying Section)

The intermediate conveying drum 34 is provided at the intermediate conveying section 58 so as to be rotatable. A sheet held at the surface of the intermediate conveying drum 34 via the holding member 32 provided at the intermediate conveying drum 34, is conveyed downstream by the rotation of the intermediate conveying drum 34.

(Image Forming Section)

The image forming drum 36 is provided at the image forming section 16 so as to be rotatable. A sheet held at the surface of the image forming drum 36 via the holding member 32 provided at the image forming drum 36, is conveyed downstream by the rotation of the image forming drum 36.

A head unit 66, that is structured by single-pass inkjet line heads 64, is disposed above the image forming drum 36 close to the surface of the image forming drum 36. At the head unit 66, the inkjet line heads 64 of at least YMCK that are basic colors are arrayed along the peripheral direction of the image forming drum 36, and form images of the respective colors on the processing liquid layer that was formed on the recording surface of the sheet at the processing liquid coating section 14.

The processing liquid has the effect of making the color material (pigment) and the latex particles that are dispersed within the ink aggregate on the processing liquid, and forms aggregates at which flowing of the color material and the like do not arise on the sheet. As an example of the reaction between the liquid ink and the processing liquid, by using a mechanism in which pigment dispersion is destroyed and aggregates are formed by including an acid within the processing liquid and lowering the pH, running of the color material, color mixing between the inks of the respective colors, and dot interference due to uniting of liquids at the time when the ink drops land are avoided.

The inkjet line heads 64 carry out ejecting of droplets synchronously with an encoder (not illustrated) that is disposed at the image forming drum 36 and detects the rotating speed. Due thereto, the landing positions of the droplets are determined highly accurately, and unevenness of the dots can be reduced independently of deviations of the image forming drum 36, the precision of a rotating shaft 68, and the surface speed of the drum.

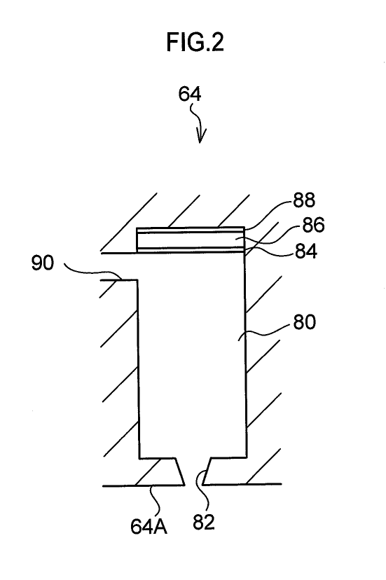

A portion of a longitudinal sectional view of the inkjet line head 64 is shown in FIG. 2.

As shown in FIG. 2, at the inkjet line head 64, liquid ink is filled in a pressure chamber 80, and a nozzle 82, that ejects ink drops on the basis of image information, is provided at a nozzle surface 64A. Note that, in order to avoid complication, only one set of the pressure chamber 80 and the nozzle 82 are illustrated in FIG. 2, but the inkjet line head 64 is provided with plural sets of the pressure chamber 80 and the nozzle 82. At the nozzle surface 64A, the inkjet line head 64 has an elongated shape in which the plural nozzles 82 are arrayed in a direction (the main scanning direction) that is substantially orthogonal to the conveying direction of the sheet (the subscanning direction).

An actuator 86, that causes liquid ink to be ejected from the nozzle 82 while imparting pressure to the liquid ink filled in the pressure chamber 80, is joined to a pressure-applying plate (a vibrating plate that also serves as a common electrode) 84 that structures a surface (the ceiling surface in FIG. 2) of the pressure chamber 80. Individual electrodes 88 are provided at the surfaces of the respective actuators 86, which surfaces are opposite the surfaces thereof that contact the pressure-applying plate 84.

Due to the actuator 86 deforming due to driving voltage being applied between the individual electrode 88 and the common electrode, the volume of the pressure chamber 80 changes, and an ink drop is ejected from the nozzle 82 due to the change in pressure accompanying this. A piezoelectric element using a piezoelectric body of lead zirconate titanate, barium titanate or the like, may be used as the actuator 86. After the liquid ink is ejected, when the displacement of the actuator 86 returns to the original state, new liquid ink is supplied to the pressure chamber 80 from a liquid ink supply port 90.

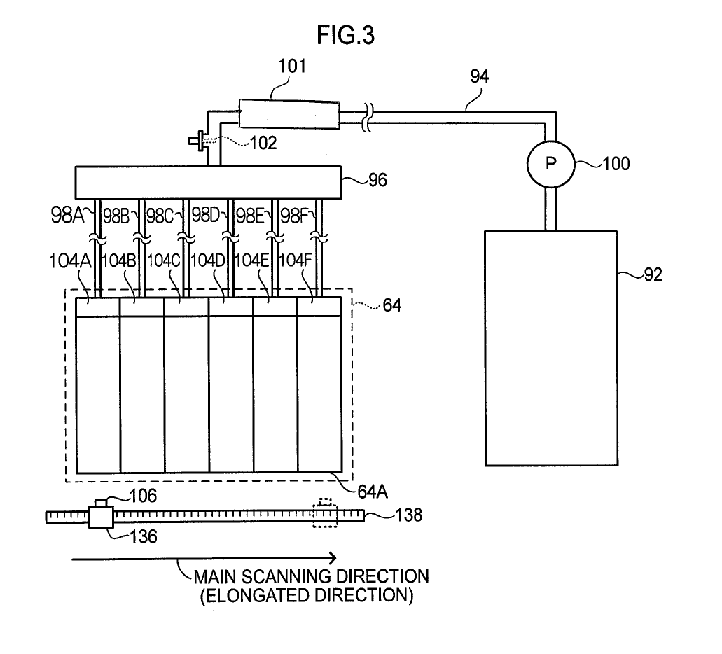

The supply path of the liquid ink from an ink tank 92 to the inkjet line head 64 is shown in FIG. 3.

The ink tank 92 supplies liquid ink to the inkjet line head 64 via an ink supply path 94, a manifold 96, and plural branch paths 98A through 98F.

A pump 100 is provided at the ink supply path 94. Liquid ink within the ink tank 92 is fed-out to the manifold 96 by the pump 100. In the image forming device 10 relating to the present exemplary embodiment, the ink supply path 94 is joined to the substantial center of the manifold 96.

An ink temperature sensor 102, that detects the temperature of the liquid ink fed-out to the manifold 96 (hereinafter called “ink temperature”), is provided at the ink supply path 94 before the portion joined to the manifold 96. By contacting the liquid ink flowing within the ink supply path 94, the ink temperature sensor 102 detects the temperature of the liquid ink flowing into the manifold 96. In the image forming device 10, a thermocouple is used as the ink temperature sensor 102. However, the ink temperature sensor is not limited to a thermocouple, and a thermistor, a platinum resistance temperature sensor, a copper resistance temperature sensor, or another temperature sensor may be used. Further, the ink supply path 94 is provided with a temperature adjuster 101 and is configured to supply the ink at a predetermined temperature to the manifold 96.

The branch paths 98A through 98F are joined to the manifold 96, and the liquid ink is supplied to the inkjet line head 64 via the branch paths 98A through 98F. When there is a need to differentiate between the respective branch paths 98A through 98F, the reference letter A through F will be appended to the reference numeral. When there is no need to differentiate between the respective branch paths 98A through 98F, the reference letters A through F will be omitted.

The inkjet line head 64 is structured by plural modules 104A through 104F that are divided in the main scanning direction. At the respective modules 104A through 104F, the nozzles 82 are formed at the nozzle surface 64A, and the plural pressure chambers 80 in which the liquid ink is filled are arrayed in the main scanning direction. The corresponding branch paths 98 are joined to the modules 104 respectively. When there is a need to differentiate between the respective modules 104A through 104F, the reference letter A through F will be appended to the reference numeral. When there is no need to differentiate between the respective modules 104A through 104F, the reference letters A through F will be omitted. In the image forming device 10 relating to the present exemplary embodiment, there are six of the modules 104, but the number of modules is not limited to six.

In the image forming device 10, the temperature of a predetermined range of the nozzle surface 64A is detected by a nozzle surface temperature sensor 106 (details of which will be described later) that moves relatively in the elongated direction of the inkjet line head 64.

The temperature of the periphery of the image forming section 16 (hereinafter called “environment temperature”) is detected by an environment temperature sensor 67 that is shown in FIG. 1. In the image forming device 10 relating to the present exemplary embodiment, a thermocouple is used as the environment temperature sensor 67. However, the environment temperature sensor is not limited to a thermocouple, and another temperature sensor such as a thermistor, a platinum resistance temperature sensor, a copper resistance temperature sensor, an infrared thermometer or the like may be used.

Due to the rotation of the image forming drum 36, the sheet, on whose recording surface an image is formed, is conveyed to an intermediate conveying section 70 that is provided between the image forming section 16 and the ink drying section 18. Because the structure of the intermediate conveying section 70 is substantially the same as that of the intermediate conveying section 58, description thereof is omitted.

As shown in FIG. 4, the head unit 66 is mounted to a ball screw 110 that is disposed parallel to the rotating shaft 68 of the image forming drum 36. A guide shaft 110G is disposed beneath the ball screw 110, parallel to the ball screw 110. A guide rail 112 is provided at the lower side of the head unit 66. The guide rail 112 is disposed parallel to the ball screw 110. Guide grooves 112A, with which engaging portions (not shown) that project from the bottom surface of a head housing 65 engage, are formed in the guide rail 112. The head unit 66 can move along the guide grooves 112A.

The ball screw 110, the guide shaft 110G and the guide rail 112 extend from an image forming position that is above the image forming drum 36 to a maintenance position that is above the maintenance section 120 for carrying out maintenance on the inkjet line head 64. The ball screw 110 is rotated by an unillustrated driver, and due to the rotation thereof, the head unit 66 moves between the image forming position and the maintenance position.

(Maintenance Section)

As shown in FIG. 4, the maintenance section 120 is disposed adjacent to the image forming section 16 along the axial direction of the image forming drum 36, and carries out maintenance operations such as cleaning of the nozzle surfaces 64A of the inkjet line heads 64, discharging of ink whose viscosity has increased, and the like. The maintenance section 120 has a wiping unit 122, a coating unit 124, a waste liquid tray 126, a nozzle cap 128 and the aforementioned nozzle surface temperature sensors 106.

The nozzle cap 128 is a cap for covering the nozzle surfaces 64A of the inkjet line heads 64, and is used when sucking ink whose viscosity has increased from the nozzles by making the outer side of the nozzle surfaces 64A be negative pressure, and when carrying out dummy jetting that ejects ink from the nozzles for the purpose of maintenance rather than image recording. The waste liquid tray 126 is provided beneath the nozzle cap 128. An unillustrated feed-out path for feeding the waste liquid out to an unillustrated waste liquid ink tank is connected to the floor portion of the waste liquid tray 126.

The coating unit 124 has a coating roller 130 and a cleaning liquid tray 132.

The rotating shaft of the coating roller 130 is disposed in a direction orthogonal to the rotating shaft 68 of the image forming drum 36, and the coating roller 130 can rotate around the rotating shaft. The outer surface of the coating roller 130 is formed in an arc shape in the axial direction as well so as to run along (follow) the nozzle surfaces 64A of the plural (four in the present exemplary embodiment) inkjet line heads 64 that are lined-up. The lower side of the coating roller 130 is immersed in the cleaning liquid that is stored in the cleaning liquid tray 132. Due to rotation of the coating roller 130, the cleaning liquid is drawn-up, and a film of the cleaning liquid can be formed on the outer surface of the coating roller 130. The rotating direction of the coating roller 130 is in the same direction as the moving direction of the head unit 66 at the time of cleaning.

The coating of the cleaning liquid onto the nozzle surfaces 64A is carried out by the head unit 66 passing by the upper side of the coating roller 130. At this time, the coating roller 130 does not contact the nozzle surfaces 64A of the inkjet line heads 64. Only the cleaning liquid that has been drawn-up contacts the nozzle surfaces 64A, and the cleaning liquid is coated on the nozzle surfaces 64A.

At the wiping unit 122, a wiping sheet 134 is made to contact the nozzle surfaces 64A of the inkjet line heads 64, and wipes the cleaning liquid coated on the nozzle surfaces 64A. The wiping unit 122 is disposed so as to be apart from the coating unit 124. A polyester or polypropylene fabric having indentations and protrusions on the surface thereof can be used as the wiping sheet 134.

The nozzle surface temperature sensor 106 detects the temperature of a predetermined range of the nozzle surface 64A in a non-contact manner. In the image forming device 10 relating to the exemplary embodiment, plural (four in the exemplary embodiment) of the nozzle surface temperature sensors 106 are disposed at a carrier 136 so as to face the nozzle surfaces 64A of the inkjet line heads 64 of YMCK, respectively. Further, although infrared ray temperature sensors are used as the nozzle surface temperature sensors 106, the nozzle surface temperature sensors are not limited to the same provided that they are non-contact-type temperature sensors.

A ball screw 138 is mounted to one end of the carrier 136, and a guide shaft 138G is mounted to the other end. The ball screw 138 and the guide shaft 138G are disposed above the waste liquid tray 126 so as to be parallel to the moving direction of the head unit 66. When the head unit 66 moves above the waste liquid tray 126, the ball screw 138 is rotated by an unillustrated driver. Due to this rotation, the carrier 136 moves the nozzle surface temperature sensors 106 in the main scanning direction. The nozzle surface temperature sensors 106 can thereby move reciprocally between position A and position B in FIG. 4.

(Ink Drying Section)

The ink drying drum 38 is provided at the ink drying section 18 shown in FIG. 1, so as to be rotatable. Plural hot air nozzles 72 and IR heaters 74 are disposed at the upper portion of the ink drying drum 38 so as to be near the surface of the ink drying section 18. Due to the warm air from the hot air nozzles 72 and the IR heaters 74, at the region of the sheet where the image is formed, the solvent that was separated by the color material aggregating action is dried, and a thin-film image layer is formed.

The warm air is usually set to 50° C. to 70° C., although it differs in accordance with the conveying speed of the sheet as well. The evaporated solvent is discharged to the exterior of the image forming device 10 together with air, and the air is recovered. The air may be cooled by a cooler/radiator or the like, and recovered as ink liquid.

Due to the rotation of the ink drying drum 38, the sheet, on whose recording surface the image is dried, is conveyed to an intermediate conveying section 76 that is provided between the ink drying section 18 and the image fixing section 20. Because the structure of the intermediate conveying section 76 is substantially the same as that of the intermediate conveying section 58, description thereof is omitted.

(Image Fixing Section)

The image fixing drum 40 is provided at the image fixing section 20 so as to be rotatable. At the image fixing section 20, the latex particles within the image layer, that is a thin layer that was formed on the ink drying drum 38, are subjected to heat and pressure and fused, and the image fixing section 20 has the function of fixing them on the sheet.

A heating roller 78 is disposed at the upper portion of the image fixing drum 40 so as to be near the surface of the image fixing drum 40. At the heating roller 78, a halogen lamp is built-in within a metal pipe of aluminum or the like that has good thermal conductivity, and thermal energy of greater than or equal to the Tg temperature of the latex is provided by the heating roller 78. Due thereto, the latex particles are fused and fixed by being pushed into the indentations and protrusions on the sheet, and the unevenness of the surface of the image can be leveled and glossiness can be obtained.

A fixing roller 79 is provided downstream of the heating roller 78. The fixing roller 79 is disposed in a state of press-contacting the surface of the image fixing drum 40, and nipping force is obtained between the fixing roller 79 and the image fixing drum 40. Therefore, at least one of the fixing roller 79 and the image fixing drum 40 has an elastic layer at the surface thereof, and has a uniform nip width with respect to the sheet.

The sheet, on whose recording surface an image is fixed by the above-described processes, is conveyed by the rotation of the image fixing drum 40 toward the discharging section 21 that is provided downstream of the image fixing section 20.

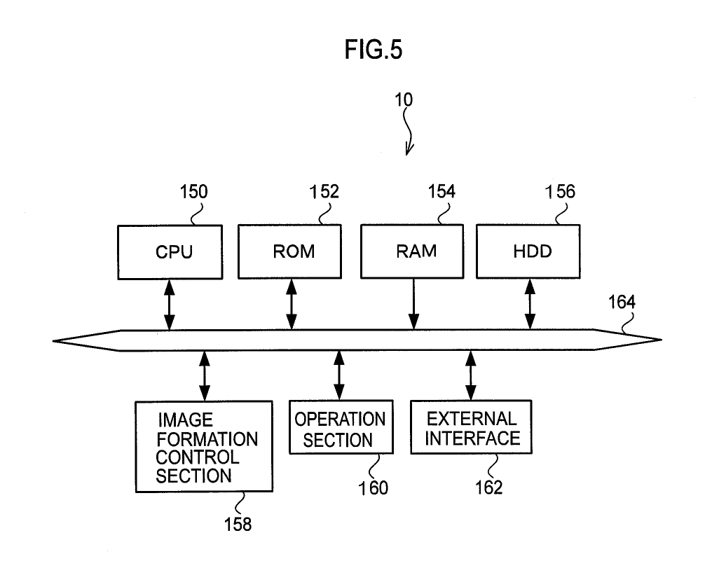

The main structures of the electrical system of the image forming device 10 are shown in FIG. 5.

The image forming device 10 has a CPU (Central Processing Unit) 150 that governs the operations of the image forming device 10 overall, a ROM (Read Only Memory) 152 in which various programs, various parameters, various table information and the like are stored in advance, a RAM (Random Access Memory) 154 that is used as a work area or the like at the time of execution of various programs by the CPU 150, and an HDD (Hard Disk Drive) 156 that stores various types of information such as image information that is received via an external interface 162 that will be described later, and the like.

The image forming device 10 has an image formation control section 158 that controls the operations of the image forming section 16, the ink drying section 18 and the like when processing that forms an image that is based on the image information onto a sheet (hereinafter called “image forming processing”) is carried out, an operation section 160 at which are provided operation buttons or a ten-key by which various types of operational instructions are inputted and a display for displaying various messages and the like, and the external interface 162 that transmits and receives various types of information, such as image information and the like, to and from external terminal devices.

The CPU 150, the ROM 152, the RAM 154, the HDD 156, the image formation control section 158, the operation section 160 and the external interface 162 are electrically connected to one another via a system bus 164. Accordingly, the CPU 150 can carry out access to the ROM 152, the RAM 154 and the HDD 156, transmission and reception of various types of information to and from the terminal devices via the external interface 162, control of the operations of the image forming section 16, the ink drying section 18 and the like via the image formation control section 158, and the display of various messages and the like by the operation section 160 and learning of the operated state of the operation section 160.

At the image forming device 10 in which the liquid ink filled in the pressure chambers 80 is ejected from the nozzles 82, there are cases in which air bubbles form in the liquid ink filled in the pressure chamber 80 and a flow amount of the liquid ink in the pressure chamber 80 and a flow path that communicates with the pressure chamber 80 decreases due to flow path resistances that arise therein. When the flow amount decreases, the effect of an external temperature increases, and as a result, an increase in the temperature of the liquid ink and an increase in the temperature of the inner walls and the like of the pressure chamber 80, are higher than in a case in which air bubbles have not formed in the liquid ink.

Thus, in the image forming device 10, if a temperature higher than a predetermined temperature is detected by the nozzle surface temperature sensor 106, the inkjet line head 64 is controlled, by driving the actuator 86, so as to continuously eject ink drops from the plural nozzles 82. Air bubble discharging processing, that forcibly discharges air bubbles together with liquid ink from the nozzles 82, is thereby carried out. A method of forcibly ejecting ink drops from the nozzles 82 is not limited to the above, and the inkjet line head 64 may be controlled such that a pressure is applied to the liquid ink inside flow paths that respectively communicate with the plural nozzles 82 and the liquid ink is continuously ejected from the plural nozzles 82. Specifically, in order to forcibly discharge the liquid ink and the air bubbles from the nozzle 82, a pressure purge can be adopted in which pressure is accumulated (increased) in the flow paths that communicate with the plural nozzles by supplying the liquid ink from the ink tank 92, and then the pressure is released. Alternatively, a method can be adopted in which the nozzle surface is covered and sealed by a hollow nozzle cap 128 by the maintenance section 120 and suction of air is performed via the cap (i.e., a suction purge).

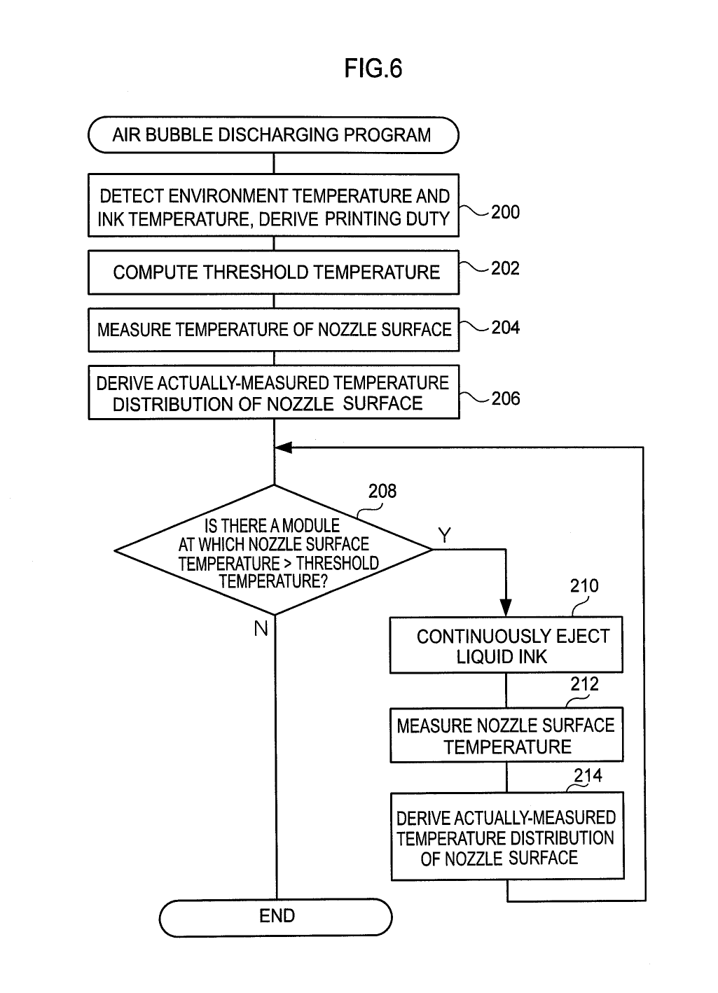

Operation of the image forming device 10 relating to the present exemplary embodiment will be described with reference to FIG. 6. FIG. 6 is a flowchart showing the flow of processing of an air bubble discharging program that is executed by the CPU 150 when the image forming processing ends and the inkjet line heads 64 move to the maintenance section 120. The air bubble discharging program is stored in advance in a predetermined area of the ROM 152 that serves as a storage medium.

In step 200, the environment temperature sensor 67 is made to detect the environment temperature at the periphery of the inkjet line heads 64, the ink temperature sensor 102 is made to detect the ink temperature, and the driving frequency of the inkjet line heads 64 (hereinafter called “printing duty”) is derived.

In the image forming device 10 relating to the present exemplary embodiment, the proportion of the time that the actuators 86 were driven, among the time needed for the image forming processing that was executed before the air bubble discharging processing is executed, is derived for each of the modules 104 as the printing duty. The time needed for the image forming processing, and the time that the actuators 86 of each module 104 are driven, are stored in the RAM 154.

In step 202, a threshold temperature is computed by adding the temperature corresponding to the printing duty of the corresponding module 104 of the plural modules 104 (hereinafter called “risen temperature”) to the temperature (hereinafter called “reference temperature”) of the nozzle surface 64A along the main scanning direction in a state in which the inkjet line head 64 is not driven, which temperature of the nozzle surface 64A is determined by the environment temperature and the ink temperature. Namely, the threshold temperature is the temperature of the nozzle surface 64A when the inkjet line head 64 is driven in a state in which air bubbles do not form in the liquid ink filled within the pressure chambers 80.

In the image forming device 10, given that the reference temperature is T_{O}, the environment temperature is T_{P} and the ink temperature is T_{I}, the reference temperature T_{O} is computed by substituting the environment temperature T_{P} and the ink temperature T_{I} into the function expressed by following formula (1).

T_{O}=f(T_{P}, Tᵢ) (1)

Note that the function expressed by formula (1) shows the temperature distribution in the main scanning direction of the nozzle surface 64A that arises due to differences in the lengths of the flow paths of the liquid inks from the ink tank 92 to each of the modules 104. As described above, the ink supply path 94 is joined to the central portion of the manifold 96. Therefore, it is difficult for the liquid ink, that is supplied to the modules 104 (the modules 104C, 104D) via the branch paths 98 (the branch paths 98C, 98D) that are joined to a vicinity of the center of the manifold 96, to be affected by the environment temperature because these flow paths are short. However, the liquid ink, that is supplied to the modules 104 (the modules 104A, 104B, 104E, 104F) via the branch paths 98 (the branch paths 98A, 98B, 98E, 98F) that are joined to positions away from the center of the manifold 96, is affected more by the environment temperature because these flow paths are longer.

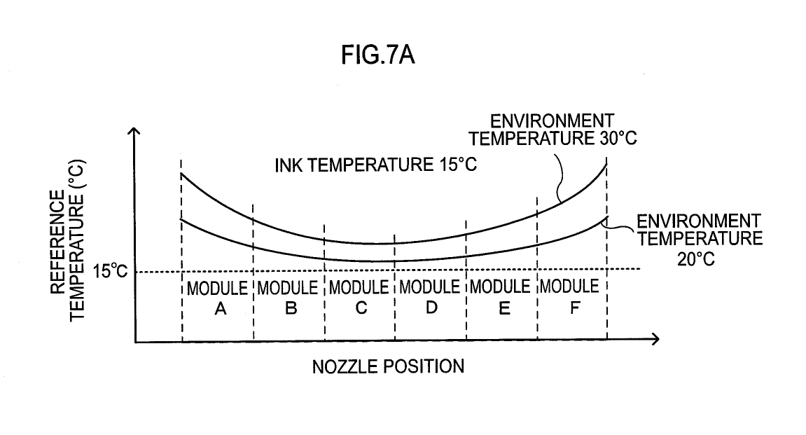

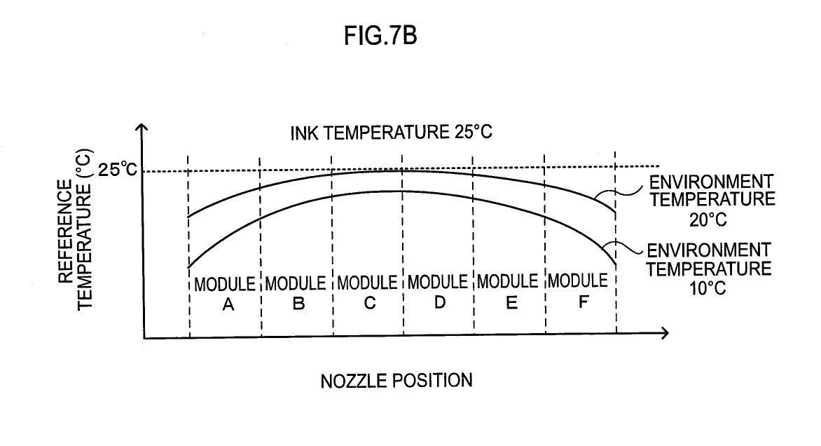

FIG. 7A and FIG. 7B show examples of surface temperature (reference temperature) distributions of the nozzle surface 64A with respect to the positions in the main scanning direction of the nozzles 82 (nozzle positions), which temperature distributions are computed by formula (1). FIG. 7A is reference temperature distributions when the ink temperature is 15° C. and the environment temperature is 30° C. and 20° C. FIG. 7B is reference temperature distributions when the ink temperature is 25° C. and the environment temperature is 20° C. and 10° C.

Due to the aforementioned differences in the lengths of the flow paths of the liquid ink, when the ink temperature is lower than the environment temperature as shown in FIG. 7A, the nozzle surface temperature becomes lower toward the central portion of the nozzle positions, and becomes higher toward the end portions. On the other hand, when the ink temperature is higher than the environment temperature as shown in FIG. 7B, the nozzle surface temperature becomes higher toward the central portion of the nozzle positions, and becomes lower toward the end portions.

Given that the threshold temperature is Tₜₕ and the printing duty is D, the threshold temperature Tₜₕ is computed by substituting the printing duty D into following formula (2).

Tₜₕ=f(T_{P}, T₁)+αD (2)

Because the printing duty D is derived for each of the modules 104, the printing duty D of the corresponding module 104 is substituted into formula (2) in accordance with the nozzle positions. α is a coefficient, and is a value that is determined in advance empirically from the relationship between the printing duty and the actually-measured temperature of the nozzle surface 64A per module 104, so that αD to be the risen temperature that corresponds to the printing duty D.

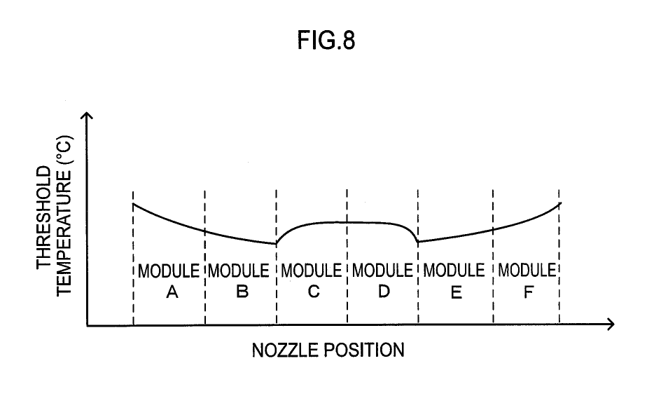

FIG. 8 shows an example of the surface temperature (threshold temperature) distribution of the nozzle surface 64A with respect to the nozzle positions of the nozzles 82, which threshold temperatures are computed by formula (2).

FIG. 8 is the threshold temperature distribution computed when the environment temperature is higher than the ink temperature and the printing duties of modules 104C, 104D are high. As shown in FIG. 8, the threshold temperatures of the nozzle positions corresponding to the modules 104 whose printing duties are high (the modules 104C, 104D), are computed by formula (2) so as to be higher than the other positions.

In step 204, the temperature of the nozzle surface 64A of the inkjet line head 64 that has moved to the maintenance section 120 is detected by the nozzle surface temperature sensor 106. In the image forming device 10, the temperature of the nozzle surface 64A is detected while the nozzle surface temperature sensor 106 is moved from position A to position B shown in FIG. 4 by the carrier 136, and thereafter, the carrier 136 is returned to position A.

In the image forming device 10, the temperature of the nozzle surface 64A is detected by the nozzle surface temperature sensor 106 only during the time when the nozzle surface temperature sensor 106 is being moved from position A to position B by the carrier 136. However, also during the time when the nozzle surface temperature sensor 106 is returned from position B to position A by the carrier 136, the nozzle surface temperature sensor 106 may be made to detect the temperature of the nozzle surface 64A, and the average value of the temperature of the nozzle surface 64A, that is detected while moving from position A to position B, and the temperature of the nozzle surface 64A, that is detected while returning from position B to position A, may be made to be the temperature of the nozzle surface 64A detected by the processing of step 204.

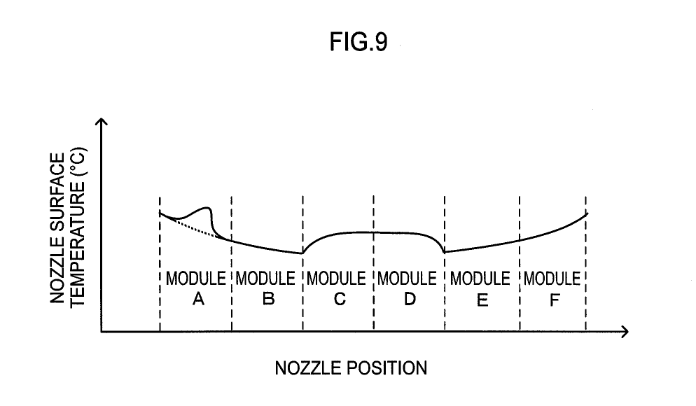

In step 206, the actually-measured temperature distribution of the nozzle surface 64A is derived from the temperature of the nozzle surface 64A detected by the processing of step 204. An example of this actually-measured temperature distribution of the nozzle surface 64A that is derived is shown by the solid line in FIG. 9.

In step 208, it is judged whether or not there is a module 104 at which the nozzle surface temperature has become higher than the threshold temperature, from the actually-measured temperature distribution of the nozzle surface 64A derived by the processing of step 206 and the threshold temperature distribution computed in step 202. If the judgment is affirmative, the routine moves on to step 210. If the judgment is negative, the present program ends.

The broken line shown in FIG. 9 is the threshold temperature computed by the processing of step 202. As shown in FIG. 9, the nozzle surface temperature of the nozzle positions corresponding to the module 104A is higher than the threshold temperature. Such a case is a case in which air bubbles have formed in the pressure chambers 80 of the module 104A, and the judgment in step 208 is affirmative.

In step 210, the inkjet line head 64 is controlled via the image forming section 16 so as to continuously eject ink drops from the nozzles 82. Due thereto, liquid ink in which air bubbles have arisen is discharged from the nozzles 82.

In the image forming device 10 relating to the present exemplary embodiment, ink drops are continuously ejected from the nozzles 82 of the module 104 at which a temperature higher than the threshold temperature was detected by the nozzle surface temperature sensor 106.

In order to continuously eject ink drops, the actuators 86, that are provided at the module 104 at which a temperature higher than the threshold temperature was detected, are continuously driven a predetermined number of times such that ink drops are ejected from the nozzles 82. However, the driving is not limited to driving of a predetermined number of times, and the actuators 86 may be driven for a predetermined time period. Alternately, in order to discharge with even more certainty the liquid ink in which air bubbles have arisen, the amount by which the actuators 86 are displaced may be made to be greater than the amount by which they are displaced in order to eject ink drops in the image forming processing.

In step 212, the temperature of the nozzle surface 64A is measured by the same processing as in step 204. In next step 214, the actually-measured temperature distribution of the nozzle surface 64A is derived by the same processing as in step 216, and the routine returns to step 208. Namely, the processings from step 208 through step 210 are repeated until the temperature of the nozzle surface 64A detected by the nozzle surface temperature sensor 106 reaches the threshold temperature.

In this way, in accordance with the image forming device 10 that is the droplet ejecting device relating to the present exemplary embodiment, the temperature of a predetermined range of the nozzle surface 64A of the elongated inkjet line head 64, in which liquid ink is filled and at which plural nozzles that eject ink drops on the basis of image information are arrayed along the main scanning direction, is detected by the nozzle surface temperature sensor 106. Further, at least one of the nozzle surface temperature sensor 106 and the inkjet line head 64 is moved relatively in the main scanning direction by the carrier. Therefore, the inkjet line head 64 can be made to be compact, and the temperature of the nozzle surface 64A of the inkjet line head 64, whose nozzle surface 64A is elongated, can be detected by a simple structure.

In the image forming device 10, the nozzle surface temperature sensor 106 detects the temperature of the nozzle surface 64A in a non-contact manner. Therefore, the temperature of the nozzle surface 64A of the elongated inkjet line head 64 can be detected more simply.

In the image forming device 10, when a temperature higher than the threshold temperature is detected by the nozzle surface temperature sensor 106, the inkjet line head 64 is controlled so as to eject ink drops continuously from the plural nozzles 82. Therefore, liquid ink in which air bubbles have formed can be expelled from the inkjet line head 64.

In the image forming device 10, the temperature of the nozzle surface 64A is detected repeatedly by the nozzle surface temperature sensor 106 and the inkjet line head 64 is controlled so as to continuously eject ink drops from the plural nozzles 82, until the temperature of the nozzle surface 64A detected by the nozzle surface temperature sensor 106 reaches a predetermined temperature. Therefore, liquid ink in which air bubbles have arisen can be more reliably expelled from the inkjet line head 64.

In the image forming device 10, the inkjet line head 64 is structured by the plural modules 104 at which the nozzles 82 are formed and at which the plural pressure chambers 80 in which liquid ink is filled are arrayed in the main scanning direction. The inkjet line head 64 is controlled such that ink drops are ejected continuously from the nozzles 82 that are provided at the module 104 at which a temperature higher than the threshold temperature is detected by the nozzle surface temperature sensor 106. Therefore, the amount of liquid ink, that is ejected in order to expel air bubbles that have formed in the liquid ink, can be suppressed.

In the image forming device 10, the threshold temperature is computed by adding a temperature, that corresponds to the driving frequency of the inkjet line head 64, to the temperature of the nozzle surface 64A in a state in which the inkjet line head 64 is not being driven, which temperature of the nozzle surface 64A is determined by the temperature of the periphery of the inkjet line head 64 and the temperature of the liquid ink before being filled in the inkjet line head 64. Therefore, the temperature of the nozzle surface 64A when air bubbles have not arisen in the filled liquid ink, can be computed simply as the threshold temperature.

In the image forming device 10, the threshold temperature is computed by adding a temperature, that corresponds to the driving frequency of the each of the plural modules 104, to the temperature of the nozzle surface 64A in a state in which the inkjet line head 64 is not being driven, which temperature of the nozzle surface 64A is determined by the temperature of the periphery of the inkjet line head 64 and the temperature of the liquid ink before being filled in the inkjet line head 64. Therefore, the temperature of the nozzle surface 64A that corresponds to each module 104 when air bubbles have not arisen in the filled liquid ink, can be computed simply as the threshold temperature.

As described above, in the present embodiment, the temperature of a predetermined range of the nozzle surface of the elongated recording head, in which a liquid is filled and at which plural nozzles that eject droplets on the basis of image information are arrayed along a predetermined direction, is detected by the temperature detector. At least one of the temperature detector and the recording head is moved relatively in the predetermined direction by the moving section.

Therefore, the recording head can be made to be compact, and the temperature of the nozzle surface of the recording head, whose nozzle surface is elongated, can be detected by a simple structure.

The temperature detector may detect the temperature of the nozzle surface in a non-contact manner. Due thereto, the temperature of the nozzle surface of the elongated recording head can be detected even more simply.

The embodiment may further include a controller that controls the recording head such that the droplets are ejected continuously from the plural nozzles when a temperature higher than a predetermined temperature is detected by the temperature detector.

When air bubbles arise in the liquid that is filled in the recording head, the amount of the liquid is reduced and it is easily affected by an external temperature. Therefore, when air bubbles are formed therein, the temperature of the liquid (ink) rises more than when air bubbles are not formed therein. In the above-described structure, when a temperature higher than a predetermined temperature is detected by the temperature detector, droplets are ejected continuously from the nozzles. Therefore, liquid in which air bubbles have arisen can be discharged from the recording head.

The controller may control the recording head such that, until the temperature of the nozzle surface detected by the temperature detector reaches the predetermined temperature, the temperature detector repeatedly detects the temperature of the nozzle surface and the droplets are continuously ejected from the plural nozzles. Due thereto, liquid in which air bubbles have arisen can be discharged from the recording head more reliably.

The droplet ejecting device may further include plural actuators corresponding to the plurality of nozzles and causes the plural nozzles to eject droplets, and the controller may control the plural actuators such that the droplets are ejected continuously from the plural nozzles.

The controller may control the recording head such that a pressure is applied to the liquid in a flow path communicated with the plural nozzles and the droplets are ejected continuously from the plural nozzles.

The recording head may be structured by plural modules at which the nozzles are formed and at which plural pressure chambers, in which the liquid is filled, are arrayed in the predetermined direction, and the controller may control the recording head such that the droplets are continuously ejected from the nozzles provided at the module at which a temperature higher than the predetermined temperature is detected by the temperature detector. Due thereto, droplets are ejected from only the nozzles of a module at which the temperature of the nozzle surface is higher than the predetermined temperature. Thus, the amount of liquid that is ejected in order to discharge the air bubbles that have arisen in the liquid, can be suppressed.

The predetermined temperature may be computed by adding a temperature corresponding to a driving frequency of the recording head to a temperature of the nozzle surface in a state in which the recording head is not driven, which temperature of the nozzle surface is determined by a temperature of a periphery of the recording head and a temperature of the liquid before being filled in the recording head. Due thereto, the temperature of the nozzle surface when air bubbles have not arisen in the filled liquid, can be computed simply as the predetermined temperature.

The predetermined temperature may be computed by adding a temperature corresponding to a driving frequency of each of the plural modules, to a temperature of the nozzle surface in a state in which the recording head is not driven, which temperature of the nozzle surface is determined by a temperature of a periphery of the recording head and a temperature of the liquid before being filled in the recording head. Due thereto, the temperature of the nozzle surface of each of the respective modules when air bubbles have not arisen in the filled liquid, can be computed simply as the predetermined temperature.

In this way, in accordance with the exemplary embodiment, the recording head can be made to be compact, and the temperature of the nozzle surface of the recording head, whose nozzle surface is elongated, can be detected by a simple structure.

Although description has been given above by using an exemplary embodiment, the technical scope of the present invention is not limited to the scope described in the above exemplary embodiment. Various changes or improvements can be added to the above exemplary embodiment within a range that does not deviate from the gist of the invention. Forms to which such changes or improvements have been added also are included in the technical scope of the present invention.

Further, the above-described exemplary embodiment does not intend to limit the inventions relating to the claims, nor is it the case that all of the combinations of features described in the exemplary embodiment are essential to the means of the present invention for solving the problems of the conventional art. Inventions of various stages are included in the above exemplary embodiment, and various inventions can be extracted by combining plural constituent features that are disclosed. Even if some of the constituent features are omitted from all of the constituent features that are shown in the exemplary embodiment, such structures from which some constituent features are omitted can be extracted as inventions provided that the effects of the present invention are obtained.

For example, the above exemplary embodiment describes a case in which liquid ink is ejected from the module 104 at which a temperature higher than the threshold temperature is detected by the nozzle surface temperature sensor 106. However, the present invention is not limited to the same, and may be a form in which, if a temperature higher than the threshold temperature is detected by the nozzle surface temperature sensor 106, liquid ink is ejected from all of the modules 104.

Further, the exemplary embodiment describes a case in which the threshold value is computed by adding, to the reference temperature, the risen temperature that corresponds to the printing duty of each of the plural modules 104. However, the present invention is not limited to the same, and may be a form in which the threshold value is computed by adding, to the reference temperature, a risen temperature that corresponds to the average value of the printing duties of all of the modules 104.

Moreover, the above exemplary embodiment describes a case in which the temperature of the nozzle surface 64A is detected while moving the nozzle surface temperature sensor 106 relative to the inkjet line head 64 by the carrier 136. However, the present invention is not limited to the same, and may be a form in which the nozzle surface temperature sensor 106 is fixed, and the temperature of the nozzle surface 64A is detected while moving the inkjet line head 64 relative to the nozzle surface temperature sensor 106.

In addition, the structure of the image forming device (see FIG. 1 through FIG. 5) described in the exemplary embodiment is an example, and, of course, unnecessary portions may be omitted and new portions may be added within a scope that does not deviate from the gist of the present invention.

Further, the flow of the processings of the air bubble discharging program (see FIG. 6) described in the above exemplary embodiment also is an example. Unnecessary steps may be omitted, new steps may be added, and the order of processings may be rearranged within a scope that does not deviate from the gist of the present invention.

What is claimed is:

1. A droplet ejecting device comprising:
a recording head that is elongated, and in which a liquid is filled, and at which a plurality of nozzles, that eject droplets on the basis of image information, are arrayed along a predetermined direction;
a temperature detector that detects a temperature of a predetermined range of a nozzle surface at which the plurality of nozzles of the recording head are arrayed; and
a moving section that moves at least one of the temperature detector and the recording head relatively in the predetermined direction.

2. The droplet ejecting device of claim 1, wherein the temperature detector detects the temperature of the nozzle surface in a non-contact manner.

3. The droplet ejecting device of claim 1, further comprising a controller that controls the recording head such that the droplets are ejected continuously from the plurality of nozzles when a temperature higher than a predetermined temperature is detected by the temperature detector.

4. The droplet ejecting device of claim 3, wherein the controller controls the recording head such that, until the temperature of the nozzle surface detected by the temperature detector reaches the predetermined temperature, the temperature detector repeatedly detects the temperature of the nozzle surface and the droplets are continuously ejected from the plurality of nozzles.

5. The droplet ejecting device of claim 3, further comprising a plurality of actuators corresponding to the plurality of nozzles and causes the plurality of nozzles to eject droplets, wherein the controller controls the plurality of actuators such that the droplets are ejected continuously from the plurality of nozzles.

6. The droplet ejecting device of claim 3, wherein the controller controls the recording head such that a pressure is applied to the liquid in a flow path communicated with the plurality of nozzles and the droplets are ejected continuously from the plurality of nozzles.

7. The droplet ejecting device of claim 3, wherein
the recording head includes a plurality of modules at which the nozzles are formed and at which a plurality of pressure chambers, in which the liquid is filled, are arrayed in the predetermined direction, and
the controller controls the recording head such that the droplets are continuously ejected from the nozzles provided at the module at which a temperature higher than the predetermined temperature is detected by the temperature detector.

8. The droplet ejecting device of claim 3, wherein the predetermined temperature is computed by adding a temperature corresponding to a driving frequency of the recording head to a temperature of the nozzle surface when the recording head is not driven, which temperature of the nozzle surface is determined by a temperature of a periphery of the recording head and a temperature of the liquid before being filled in the recording head.

9. The droplet ejecting device of claim 7, wherein the predetermined temperature is computed by adding a temperature corresponding to a driving frequency of each of the plurality of modules, to a temperature of the nozzle surface in a state in which the recording head is not driven, which temperature of the nozzle surface is determined by a temperature of a periphery of the recording head and a temperature of the liquid before being filled in the recording head.
